(19) United States
(12) Patent Application Publication
(10) Pub. No.: US 2018/0089143 A1
(43) Pub. Date: Mar. 29, 2018

(54) Method and Apparatus for Generating Accurate Energy Models for Similar Structures

(71) Applicant: United States Government, as Represented by the Secretary of the Army, Fort Belvoir, VA (US)

(72) Inventor: Patrick John Sullivan, West Point, NY (US)

(73) Assignee: United States Government, as Represented by the Secretary of the Army, Fort Belvoir, VA (US)

(21) Appl. No.: 15/279,663

(22) Filed: Sep. 29, 2016

(51) Int. Cl. G06F 17/10; G06Q 50/06

(52) U.S. Cl. CPC G06F 17/10; G05B 13/048; G06Q 50/06

(57) ABSTRACT

A method for determining the energy factor for similar buildings, the method being implemented on a computer device comprising one or more processors programmed with one or more computer program instructions that, when executed by the one or more processors, program the computer device to perform the method, the method comprising selecting a group of buildings with a similar floor plan; performing an energy audit of at least one building in the selected group of buildings. The energy audit comprises determining the thermodynamic efficiency of the structure of each building in the group of buildings, and determining the energy efficiency of at least one control system consuming energy in each building. The method also include generating a monthly energy model for each building in said selected group of buildings wherein the energy model is an estimate of the amount of energy that the at least one control system of the building consumes every hour for each month based on the thermodynamic efficiency of the structure of the building and the energy efficiency of the at least one control system. The method also includes selecting the lowest estimated energy consumption estimate from the selected group of buildings for each month and calculating an individual monthly energy factor for each building in the group and, generating a weighted score measuring the energy use of the at least one building's occupant by multiplying said individual monthly energy factor for the at least one building in said group of buildings by the actual energy used by the at least one building for that month.

### FIELD OF THE INVENTION

This invention relates in general to a method and apparatus for generating energy models for similar structures and in particular to systems and methods for modeling the consumption of energy, such as electricity, heating oil or natural gas in a structure, and for generating meaningful comparisons of the energy consumption habits of the occupants of a structure compared to the energy consumption habits of the occupants of similar structures.

### BACKGROUND OF THE INVENTION

RESNET (Residential Energy Services Network) is a non-profit, membership organization that creates the national standards for the residential energy efficiency rating and certification systems. The RESNET Home Energy Rating System, known as the HERS score, is used to give a rating on an individual home so that builders, potential home buyers, residents, and federal agencies know the level of efficiency of that individual home. The HERS score is similar to the miles per gallon sticker on a new car. Like a potential car buyer, different groups in the residential housing industry also would like to know the efficiency level of a new or an existing home, and the HERS score is that measure of energy efficiency in the home industry. The HERS score measures a home's level of efficiency by comparing it to the International Energy Conservation Code.

The HERS score is calculated using the energy model calculations similar to the equations set forth below. Each home that gets rated requires a thorough inspection of all of the components of the building. The inspection requires data on the following areas: Square footage of home, Volume of home, Window Characteristics of the structure, wall Characteristics of the structure, floor Characteristics of the structure, ceiling Characteristics of the structure, basement Characteristics of the structure, Insulation Levels, the Air Infiltration Rate, the Duct Infiltration Rate, the Furnace Efficiency, the AC Efficiency, the water Heater Efficiency and the Orientation of Home.

With all of this information, the RESNET certified energy modeling software will calculate a home's HERS score and an estimated cost of utilities for the utility rate in that home's specific area.

RESNET started in 1996 because a group in the residential mortgage industry wanted to establish a standard to measure financial savings from energy efficient features because they wanted to credit those savings in mortgage loans. Before RESNET, there was no uniform method of efficiency evaluation for the mortgage industry and a lack of standards, quality assurance, and rater certification. The RESNET system augments the International Energy Conservation Code (IECC) that is the model building code produced by national experts and is used as a starting point for state and local jurisdictions to create their own energy codes. In the IECC standards, there is a prescriptive and a performance path to code compliance. The prescriptive path sets specific minimum performance levels for each component of a building, for example minimum insulation levels, minimum window quality levels, and air infiltration levels. In contrast, the performance path sets a requirement for the overall energy efficiency level of a home. A home can have a lower energy efficiency level in one component if another component with a higher performance makes up for that lower efficiency level. This gives the builder more flexibility to get the same results. The RESNET HERS score is used for this prescriptive path, because RESNET has the rating system, quality assurance system, and rater training system in place to ensure the quality of the performance path is met.

Over the last 20 years, RESNET has grown to a national standards organization, and in 2014, RESNET rated over 33% of all new homes sold in the US. The RESNET rating system is being used in state residential building codes for minimum efficiency levels in 16 states with other states currently working towards this goal and being used in 9 states for verification of energy performance in state utility benefit programs. The RESNET rating system is currently being used by the Federal Government for tax credit qualification and for labeling homes as Energy Star because of their high level of energy efficiency.

A home that is built to the IECC 2003/2004 standards earns a rating of 100. Homes that are more energy efficient have a lower score, and homes that are less energy efficient have a higher score. A home that has a rating of 70 is 30% more efficient than a home with a rating of 100, and a home with a rating of 130 is 30% less efficient than a home with a rating of 100. A home with a rating of 0 is considered a next zero energy home because it is 100% more efficient than a home with a rating of 100. This home will likely have solar panels that will produce more energy than the home uses on an annual basis. While the HERS score is a very useful tool, the current way the HERS scores are generated fails to incorporate any real energy usage data of the residents in occupied homes. Also, as currently used HERS does not provide for comparing the energy use habits of the tenants of a structure, to the tenants of similar structures. Thus, there exist a need for an enhanced energy modeling method that allows for greater accuracy in the calculation of energy usage in a residence or similar structures and to compare the energy use habits of residents of similar structures.

Other objects and advantages of the invention will be apparent to those skilled in the art based on the following drawings and detailed description.

### BRIEF DESCRIPTION OF THE DRAWINGS

The features and advantages of the present invention will be apparent from the accompanying drawings and from the detailed description of the present invention as set forth below.

FIG. 1 is an illustration of a system embodiment of the disclosed invention for generating accurate energy factors and making energy use comparisons for structures.

FIG. 2 is an illustration of a flow diagram of an embodiment of the disclosed method for generating accurate energy factors and making energy use comparisons for similar structures.

FIG. 3 is an illustration of a flow diagram for an embodiment of generating an energy model for a home.

FIG. 4 is an illustration of a flow diagram for an embodiment of the disclosed method for creating home energy factors for a plurality of similar homes.

FIG. 5. Is an illustration of a flow diagram for an embodiment of the disclosed method for comparing the energy usage of a group of similar structures.

### DETAILED DESCRIPTION

Various systems, methods, and computer program products for an enhanced energy modeling that allows for enhanced accuracy in the calculation of energy usage in a residence or similar structure. In one embodiment, the system may be used to model the consumption of energy, such as electricity, heating oil or natural gas in a structure, and provide for meaningful comparisons in the consumption habits of the occupants compared to the energy consumption of the occupants of similar structures.

In one embodiment the energy model and methods set forth in this disclosure are applied to tract housing and are used to accurately quantify the electricity consumption habits of tenants of a particular house compared to the tenants of a comparable house. In another embodiment the energy model and methods set forth in this disclosure are applied to accurately quantify the natural gas consumption habits of tenants that house compared to the tenants of a comparable house. In yet another embodiment, the disclosed methods can be applied to commercial structures having similar layouts, such as in a strip mall.

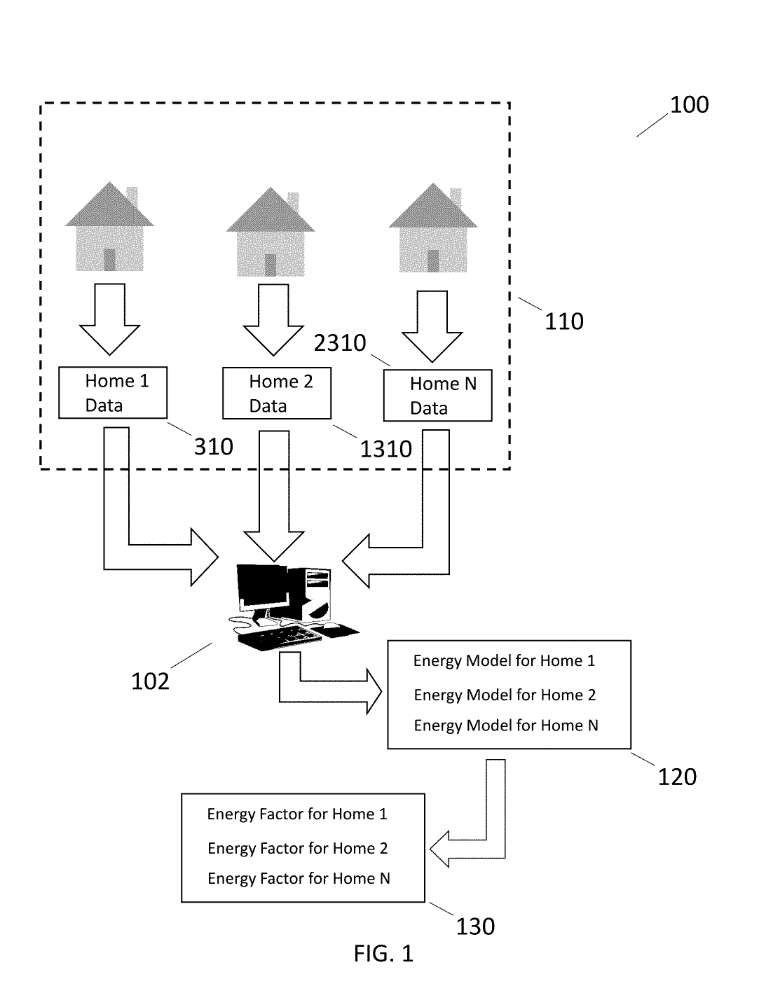

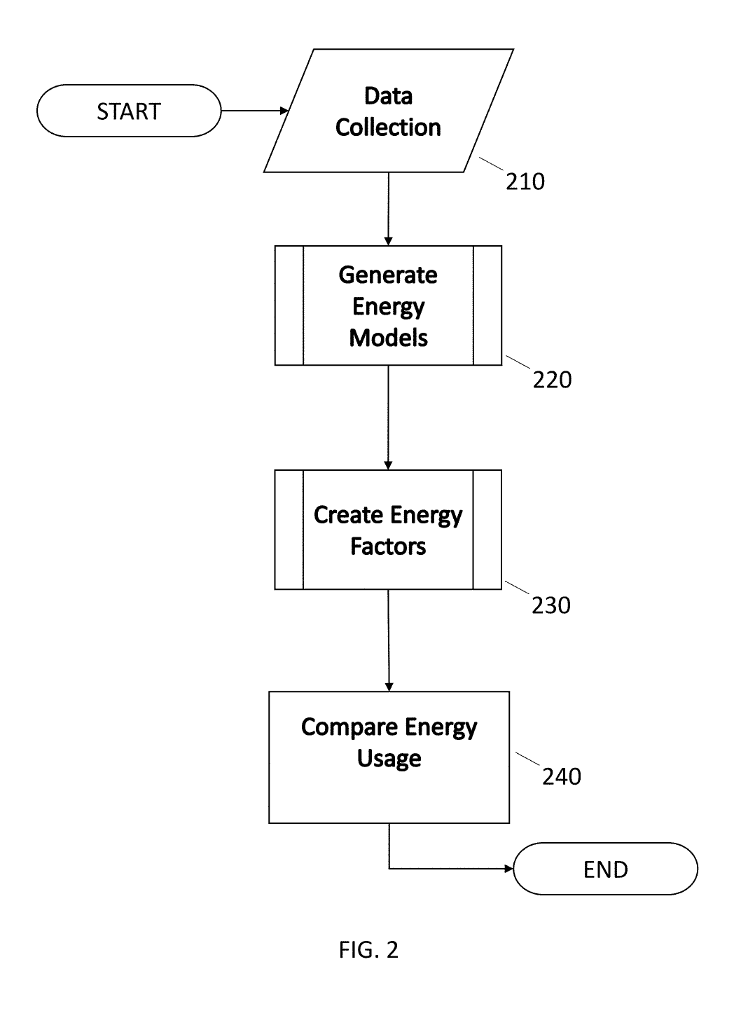

Referring now to the Figures, where like find numbers denote like elements, FIG. 1 shows an embodiment of a system 100 that employs the disclosed invention. FIG. 2 illustrates a block diagram for the disclosed method for determining the energy factor for similar buildings, the method being implemented on a computer device 102 comprising one or more processors programmed with one or more computer program instructions that, when executed by the one or more processors, program the computer device 102 to generate a precision energy model 220 and provide means for quantifying and comparing the energy use of the tenants of various building in a group of buildings 110. The buildings are preferably grouped based on the similarity of the floor plan.

Modeling a building's energy consumption starts with using thermodynamic equations to track the flow of heat out or into a building based on architecture, materials, and thermal loads. These thermal load can include heating or cooling of the space through environmental control systems. In a preferred embodiment the thermal gains from the sun adding heat to a building and the internal gains from equipment are also calculated. With this information, the building's energy usage requirement is calculated using heating and cooling equipment to get the building back to a comfortable level. In addition to these thermal loads, energy models must also account for the occupant electric plug loads. These loads are more difficult to estimate, so additional assumptions need to be made in order to make these estimates. The disclosed invention calculates the energy usage requirements for each hour during a 24 hour period, for 30 or 31 consecutive days to generate a monthly energy usage estimate.

Though there are various assumptions for internal gains, thermal gains, and occupant electric plug loads, (which each have a bearing on the absolute energy consumption of a structure) and with the knowledge that electric plug loads vary greatly based on the resident's personal electronics, in a preferred embodiment this method uses American National Standards Institute's (ANSI) residential building standards, incorporated herein by reference.

The thermodynamic equations are used to track heat flow moving out of a home on a cold day and into a home on a hot day, this section provides an illustrative example of how to calculate these values. For example the basic equations and process are as follows:

$$q = UA ( {T}_{i} - {T}_{a} ) \\ where \text{:} \\ q is the heat loss rate ( \frac{Btu}{hr} ) \\ U is the thermal conductance or U \text{-} Value ( \frac{Btu \text{/} hr}{{ft}^{2} ° F .} ) \\ A is the Area ( {ft}^{2} ) \\ {T}_{i} is the Indoor Temperature ( ° F . ) \\ {T}_{a} is the Ambiant or Outdoor Temperature ( ° F . ) \qquad [ EQ 1 ]$$

This heat loss rate is calculated every hour for every external portion of the building. The ambient temperature for every hour can either use the actual ambient temperature or the ANSI standard for expected temperature at a given hour at a given location using historical data. Calculating the heat loss rate can get complicated for all envelope surfaces with all different types of construction materials, insulation levels, radiation from surfaces, surfaces causing convective currents, and edge effects from windows, but all of these different thermal issues are accounted for in the following equation that results in the total heat loss rate for a given hour:

qₜₒₜₐₗ=q_{walls}+q_{windows}+q_{ceiling}+q_{floor}+q_{doors}+q_{infiltration} [EQ 2]

The heat loss due to infiltration is the only portion of EQ 2 that must be adjusted from EQ 1 in order to calculate the heat loss from the unconditioned outside air that is entering the home and mixing with the conditioned air. The basic thermodynamic equation is slightly adjusted to the following:

$${q}_{infiltration} = ρ cnV ( {T}_{i} - {T}_{a} ) \\ where \text{:} \\ {q}_{infiltration} is the heat loss rate ( \frac{Btu}{hr} ) \\ ρ is the density of air ( 0.075 \frac{lb}{{ft}^{3}} ) \\ c is the specific heat of air ( 0.24 \frac{Btu}{lb ° F .} ) \\ n is the number of air changes per hour ( ach ) \\ V is the volume of air per air change ( \frac{{ft}^{3}}{ac} ) \\ {T}_{i} is the Indoor Temperature ( ° F . ) \\ {T}_{a} is Ambiant or Outdoor Temperature ( ° F . ) . \qquad [ EQ 3 ]$$

With the result from (EQ 3) used in (EQ 2) with the other envelope conditions using (EQ 1), the total heat loss rate for that one hour is calculated. This value is then compared to the internal gains from people and equipment and the solar gains from the sun to determine the heating requirement or cooling requirement for that hour. The amount of energy to heat or cool the structure can them be calculated by determining how much electricity or natural gas at the efficiency rate of the heating or cooling equipment will be needed to get the home back to the comfort zone.

The step by step process of these thermodynamic equations are certified by the ANSI and RESNET (Residential Energy Services Network) in great detail and can be found in ANSI-RESNET 301, incorporated herein by reference. Other implementations and uses of the system will be apparent based on the disclosure herein. Having provided a broad overview of a use of the system, various system components will now be described.

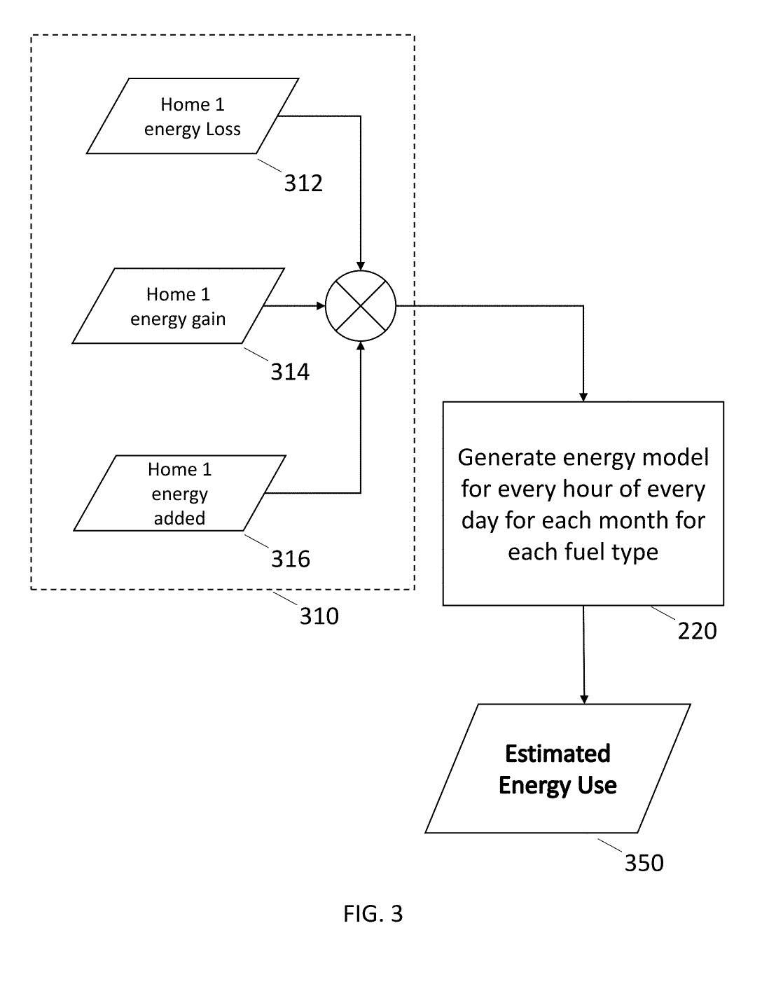

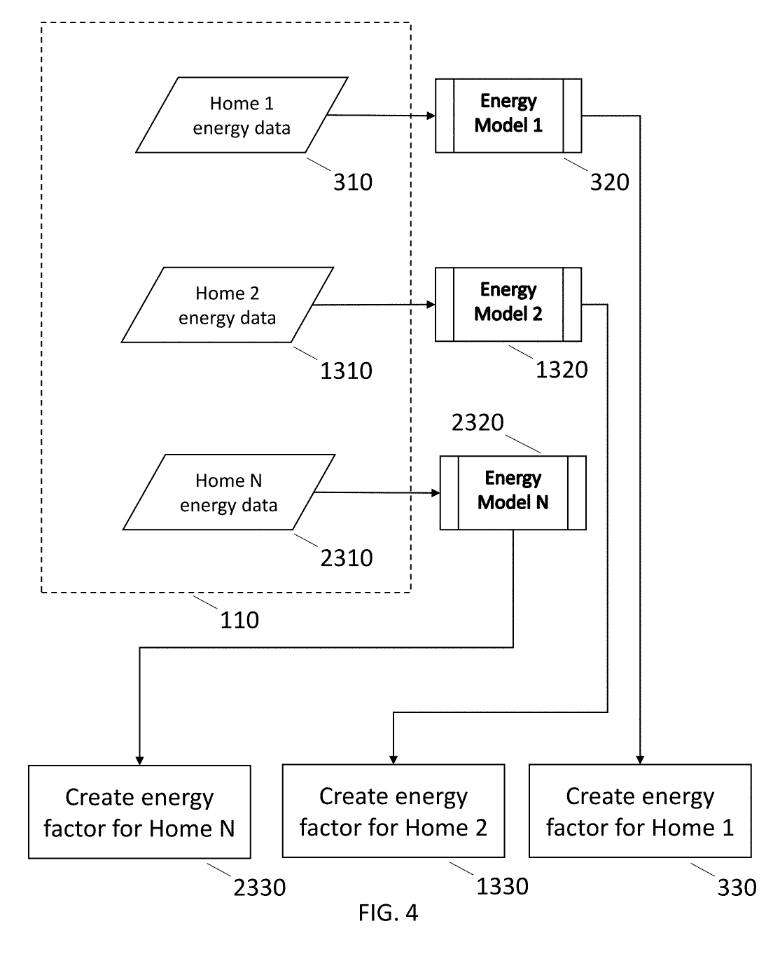

Referring now to FIG. 4 with continued reference to FIGS. 1 and 2 FIG. 4 shows the grouping of similar homes/building/or structures with similar floor plans and structural layouts 110. Preferably, data 310, 1310, 2310 is collected via an energy audit which is performed on each building in the group of selected buildings. Referring now to FIG. 3 with continued reference to FIG. 4, the energy audit comprises determining the thermodynamic efficiency of the structure of each said building 310, 1310, and 2310 in said group of buildings 110, and determining the energy efficiency of at least one control system consuming energy in each building. The control system of the building is preferably an environmental control system such as the Heating, Venting and Air Conditioning (HVAC) system or a furnace, however the control system may be a water heater, electric fans, heater, lights, or other temperature or environmental control system.

The energy audit consists of recording measurements and characteristics for things such as the walls, windows, floors, ceiling, basement, doors, air infiltration rate, furnace efficiency, air conditioner efficiency, water heater efficiency, amount of direct sunlight, orientation of home, middle vs end unit, and family size. If a group of homes has differences in things like the air infiltration rate, HVAC equipment, or orientation, a shortened energy audit is conducted to record this information for every home in the group. In one exemplarily embodiment the energy audit determines the energy consumption of a control system that consumes electricity. In other embodiments the control system consuming energy is a system that consumes natural gas or heating oil.

The energy audit further comprises determining the energy efficiency said at least one control system by collecting data on the energy use of said at least one building's climate control system, for example, collecting data on the energy use of the building's air conditioning system. In another exemplarily embodiment the energy audit determines the energy efficiency of the buildings environmental control system by collecting data on the energy use of said at least one building's furnace. The energy audit can also include collecting data on the energy use of said a building's water heater.

In other embodiments the energy audit will consider the air infiltration rate of the building's structure and or the duct infiltration rate of the building's climate control system and weight the buildings energy model to compensate for the duct infiltration rate.

In other embodiments the energy audit incorporates an assigned weight factor for each building's monthly energy consumption to compensate for the physical location and orientation of the building in relation to the physical location of the building having the lowest estimated energy consumption estimate from said selected group of buildings. For example a building oriented with two walls exposed to afternoon sunlight may have a lower weight factor assigned to it for the summer months to compensate for solar heating in relation to a building with one exposed wall, or a building that is largely shaded. With continued reference to FIGS. 2, 3 and 4, based on the data 310, 1310, 2310 collected in the energy audit, a monthly energy model, 220 is generated for each building. The energy models 320, 1320, 2320 are an estimates of the amount of energy that at least one control system of the building consumes every hour for each month based on the thermodynamic efficiency of the structure of the building and the energy efficiency of the control system.

Referring again to FIG. 3, with continued reference to FIG. 2, FIG. 3 shows a flow diagram for the construction of an energy model 220. The engineering basis for this modeling is in basic thermodynamics. For example, the amount of energy (heat) that needs to be added to a home for a given hour 316 depends on the amount of energy (heat) loss through the exterior envelope 312, the energy (heat) loss from the air infiltration rate, and the amount of heat gained through direct sunlight 314. The model combines these thermodynamic principle to create a thermodynamic efficiency model. This calculation is completed for every hour of every day for a month to get the heating requirement for the month and allows the generation of estimated energy usage 220 for the entire month. Currently, software packages like EnergyGauge and RemRate have specialized in estimating residential energy to make this estimation easier. This step results in the predicted energy usage 220 for each month for each fuel type (electric and gas).

As shown is FIG. 4, a monthly energy model for each building in said selected group of buildings 320, 1320, 2320 is generated. Each structure's energy model 320, 1320, 2320 is used to predict the energy usage for that particular structure over the course for a given month. The predicted energy usage 350 is used to calculate an individual energy factor 330, 1330, 2330 for each individual structure. To generate the energy factor 230, the minimum value for predicted energy usage for all the homes in the selected group is divided by each home's predicted energy usage. This results in an individual energy factor 5330, 6330, 7330 with a value less than one for each home for each month for each fuel type. For example, homes in a neighborhood may use electricity and natural gas powered control systems for environmental controls. Each home therefore will have 12 monthly energy factors for its electricity usage and 12 monthly energy factors for its natural gas usage.

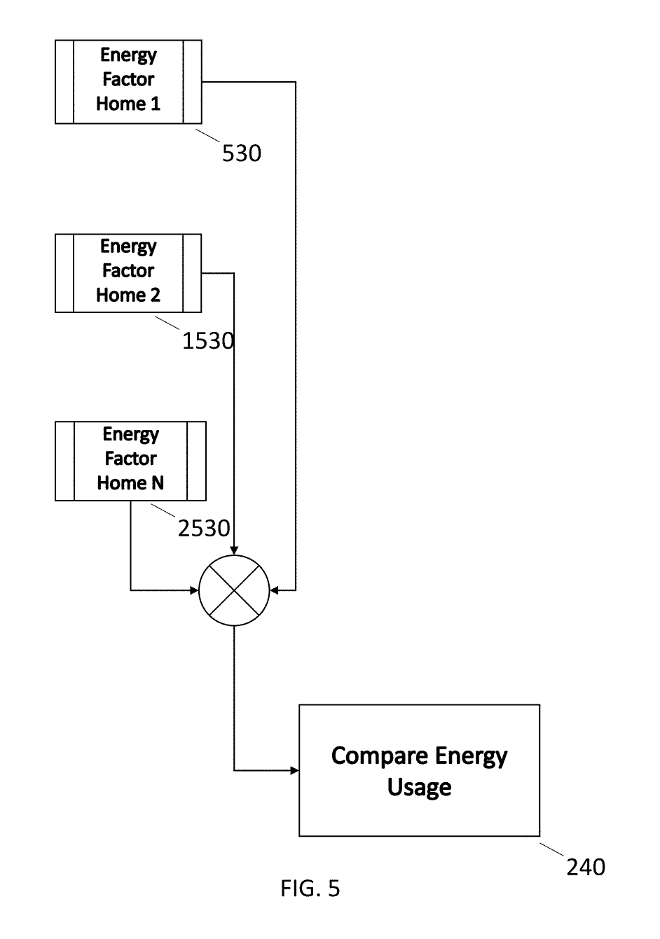

Referring to FIG. 5, with continued reference to FIGS. 2, and 4 the various monthly energy factor for an individual structure 530, 1530, 2530 is used to generate a weighted score measuring the energy use of the home's occupants by multiplying the calculated energy factor for a particular month by the actual energy used by that particular structure for a particular month. The weighted score, generated at the end of the end of each month, allows the energy lifestyle of the residents of each structure in a group to be compared 240 to other members of the group 110. The weighted score is an adjusted energy value that removes the inefficiency differences in the like structures.

In the Figures, like numerals represent equivalent elements or features. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

1. A method for determining the energy factor for similar buildings comprising:
selecting a group of buildings with a similar floor plan;
performing an energy audit of at least one building in said selected group of buildings; said energy audit comprising determining the thermodynamic efficiency of the structure of each said building in said group of buildings, and determining the energy efficiency of at least one control system consuming energy in each building;
generating a monthly energy model for each building in said selected group of buildings wherein said energy model is an estimate of the amount of energy that said at least one control system of said building consumes every hour for each month based on the thermodynamic efficiency of the structure of said building and the energy efficiency of said at least one control system;
selecting the lowest estimated energy consumption estimate from said selected group of buildings for each month and calculating an individual monthly energy factor for each building in said group according to the relation:
$$Monthly Energy Factor = \frac{Monthly Group Minimum}{Predicted Monthly Energy Use}$$

2. The method of claim 1, further comprising comparing said energy usage of a plurality of said buildings from said selected group of buildings by multiplying said individual monthly energy factor for at least one building in said group of buildings by said actual energy used by said at least one building for that month to generate a weighted comparison of the energy use practices of said at least one building's occupant.

3. The method of claim 1, wherein said at least at least one control system consuming energy is a system that consumes electricity.

4. The method of claim 1, wherein said at least at least one control system consuming energy is a system that consumes natural gas or heating oil.

5. The method of claim 1, wherein said energy audit further comprises determining the energy efficiency said at least one control system by collecting data on the energy use of said at least one building's climate control system.

6. The method of claim 2, wherein said energy audit further comprises determining the energy efficiency said at least one control system by collecting data on the energy use of said at least one building's air conditioning.

7. The method of claim 4, wherein said energy audit further comprises determining the energy efficiency said at least one control system by collecting data on the energy use of said at least one building's furnace.

8. The method of claim 1, wherein said energy audit further comprises determining the energy efficiency said at least one control system by collecting data on the energy use of said at least one building's water heater.

9. The method of claim 5, wherein said energy audit further comprises determining the air infiltration rate of the building's structure.

10. The method of claim 6, wherein said energy audit further comprises determining the duct infiltration rate of the building's climate control system and weighting the buildings energy model to compensate for the duct infiltration rate.

11. The method of claim 5, wherein said energy audit further comprises weighting said at least one building's monthly energy factor to compensate for the physical location and orientation of said at least one building in relation to the physical location of the building having the lowest estimated energy consumption estimate from said selected group of buildings.

12. The method of claim 5, wherein selecting a group of buildings with a similar floor plan further comprises selecting a group of buildings that have similar square footage and volume

13. The method of claim 10, wherein selecting a group of buildings that have similar square footage and volume further comprises selecting a group that has similar window, wall and ceiling characteristics.

14. The method of claim 4, wherein said energy audit further comprises determining the energy efficiency said at least one control system by collecting data on the energy use of said at least one building's furnace and weighting said data base on said control system's duct infiltration rate.

15. A method for determining the energy factor for similar buildings comprising:
selecting a group of buildings with a similar floor plan;
performing an energy audit of at least one building in said selected group of buildings; said energy audit comprising determining the thermodynamic efficiency of the structure of each said building in said group of buildings, and determining the energy efficiency of at least one control system consuming energy in each building;
generating a monthly energy model for each building in said selected group of buildings wherein said energy model is an estimate of the amount of energy that said at least one control system of said building consumes every hour for each month based on the thermodynamic efficiency of the structure of said building and the energy efficiency of said at least one control system;
selecting the lowest estimated energy consumption estimate from said selected group of buildings for each month and calculating an individual monthly energy factor for each building in said group according to the relation:
$$Monthly Energy Factor = \frac{Monthly Group Minimum}{Predicted Monthly Energy Use}$$
and, generating a weighted score measuring the energy use of said at least one building's occupant by multiplying said individual monthly energy factor for said at least one building in said group of buildings by said actual energy used by said at least one building for that month.

16. The method of claim 15, wherein said energy audit further comprises determining the insulation levels of the building's structure and weighting the buildings energy model to compensate for the structural insulation levels.

17. The method of claim 16, wherein said energy audit further comprises determining the energy efficiency said at least one control system by collecting data on the energy use of said at least one building's climate control system.

18. The method of claim 17, wherein said energy audit further comprises determining the air infiltration rate of the building's climate control system and weighting the buildings energy model to compensate for the air infiltration rate.

19. The method of claim 18, wherein said energy audit further comprises determining the duct infiltration rate of the building's climate control system and weighting the buildings energy model to compensate for the duct infiltration rate.

20. A method for determining the energy factor for similar buildings, the method being implemented on a computer device comprising one or more processors programmed with one or more computer program instructions that, when executed by the one or more processors, program the computer device to perform the method, the method comprising:
selecting a group of buildings with a similar floor plan;
performing an energy audit of at least one building in said selected group of buildings; said energy audit comprising determining the thermodynamic efficiency of the structure of each said building in said group of buildings, and determining the energy efficiency of at least one control system consuming energy in each building;
generating a monthly energy model for each building in said selected group of buildings wherein said energy model is an estimate of the amount of energy that said at least one control system of said building consumes every hour for each month based on the thermodynamic efficiency of the structure of said building and the energy efficiency of said at least one control system;
selecting the lowest estimated energy consumption estimate from said selected group of buildings for each month and calculating an individual monthly energy factor for each building in said group according to the relation:
$$Monthly Energy Factor = \frac{Monthly Group Minimum}{Predicted Monthly Energy Use}$$
and, generating a weighted score measuring the energy use of said at least one building's occupant by multiplying said individual monthly energy factor for said at least one building in said group of buildings by said actual energy used by said at least one building for that month.
